(19) United States
(12) Patent Application Publication
(10) Pub. No.: US 2026/0350728 A1
(43) Pub. Date: Nov. 5, 2026

(54) A HOLISTIC COMPUTING SYSTEM AND METHOD FOR MAKING AND PROVIDING TECHNICAL SOLUTIONS, ESPECIALLY INVENTIVE SOLUTIONS

(71) Applicant: BF EXAQC AG, Grünwald (DE)

(72) Inventors: Bernhard Frohwitter, München (DE); Thomas Lippert, München (DE)

(73) Assignee: BF EXAQC AG, Grünwald (DE)

(21) Appl. No.: 19/487,475

(22) PCT Filed: May 22, 2024
(86) PCT No.: PCT/EP2024/064024

§ 371 Date: Nov. 24, 2025

(30) Foreign Application Priority Data
May 24, 2023 (EP) 23175052.2

(51) Int. Cl. G06Q 50/18; G06F 30/27

(52) U.S. Cl. CPC G06Q 50/184; G06F 30/27

(57) ABSTRACT

The present invention, a machine to invent, in the following “Inventer”, relates to a holistic computing system and methods for evaluating and using existing technical and scientific disclosures in documents of all kinds, including patentable and non-patentable existing art, also prior art as known in patenting, for making and providing useful new solutions in form of methods and devices—including but not limited to patentable subject matter—and inventions, and for carrying out the solutions/inventions.

The present invention, a machine to invent, in the following “Inventer”, relates to a holistic computing system and methods for evaluating and using existing technical and scientific disclosures in documents of all kinds, including patentable and non-patentable existing art, also prior art as known in patenting, for making and providing useful new solutions in form of methods and devices-including but not limited to patentable subject matter- and inventions, and for carrying out the solutions/inventions.

Artificial Intelligence (AI) based on machine learning and, in particular, supervised, self-supervised or reinforcement deep learning algorithms have become a disruptive IT technology in language and image processing, and for many current and upcoming application areas, and an important driver of computer architecture, its use and programming. In general, these emerging new software technologies (systems) require huge supercomputer capacities for training. This becomes even more necessary when several AI software systems are executed simultaneously in the way of functional parallelism and cross-training steps are to be executed. An example how these new techniques with their new requirements also transpire into chip architecture and making is shown in US 2022/0261650A1 .

In the recent years, the developments in performance of supercomputers and cloud-based clusters made it possible to access and process huge amounts of data to train learning algorithms and the corresponding AI models and tools. Machine learning and Deep learning techniques based on neural networks have also evolved rapidly. One of the most publicly prominent AI software today is ChatGPT, an AI chatbot developed by OpenAI. A very recent further development is GPT-4. An overview of recently available and capable algorithms can be found in “Top 10 Deep Learning Algorithms You Should Know in 2023”, Feb. 16, 2023, by Avijeet Biswal.

Modern language models like ChatGPT are trained on large text corpora taken from public sources such as the Internet and mixed with arbitrary proprietary sources (documents, books, instruction data gathered from human interactions, etc.). All text is encoded into so-called “tokens”, which then form the basis for all further processing steps. The input for language models is a text as a sequence of tokens with a certain maximum length, typically between 1,000 and 30,000 tokens. Altogether text datasets with hundreds of billions of words are used to train such models. State-of-the-art language-vision models fall into one of two large groups: representation learning models like CLIP (contrastive language-image pre-training) or generative models that can also produce samples of either images (stable diffusion) or text (CoCa, FLAMINGO, GPT-4). Representation learning models (CLIP; LAION open-source version openCLIP: https://github.com/mlfoundations/open_clip) learn from image-text pairs, both image and text being converted into tokens by respective vision and language transformer subnetworks first. Each input is thus a pair of an image and a text from a dataset of image-text pairs. Using so called contrastive loss, they are trained to predict a similarity between an image and a text, which is simply given by the fact of image and text caption going together in the given dataset of image-text pairs (e.g., LAION-5B is such a dataset).

Supercomputers are rapidly evolving towards systems capable of both running large simulations and training large-scale deep learning networks. With the advent of modular supercomputing systems multi-functional parallelism can be executed on system level. Such a modular system was first described in WO 2012/049247A1, which the teaching and disclosure is fully incorporated in this patent application. Modular systems may comprise several modules each of which adapted for solving specific computational tasks while running in parallel and being able to dynamically and or mutually adapt these tasks. This parallelism of subtasks can be provided in a flexible way. By making use of the dynamic Modular Supercomputing Architecture (MSA), supercomputing machines capable of research and application of large-scale AI are rapidly evolving, Springer, 2021 “JUWELS Booster-A Supercomputer for Large-Scale AI Research”. The first Supercomputers based on the dynamic MSA have reached the exascale performance level.

A modular supercomputer system provides a most efficient way to execute (multiple) AI systems with different I/O, compute power, memory requirements, as well as number representation precisions in functionally parallel mode at the same time, allowing for exchange of information and cross-training of the different elements as adopted in the present invention.

The present invention, the Inventer, is defined by the independent claims. A system according to the present invention preferably incorporates and combines aspects of both the Modular Supercomputing Architecture (MSA) and the concepts and methods of Artificial Intelligence (AI) for generating new technical and scientific solutions, methods, and intellectual property (IP). One aspect is concerned with the new well-trained system researching and combining existing technical and scientific disclosures to generate new, also inventive solutions, either based on its own inherent capabilities or triggered by user request.

Particularly, holistic computing system for making and providing new technical and scientific solutions according to the invention may comprise a modular supercomputer infrastructure, with an initial training dataset, an algorithms database, and an invention module. Further it may comprise one or more of the following units: a system manager, and a result classifier.

The modular supercomputer infrastructure preferably provides computing capability to manipulate data of the initial training datasets. A modular supercomputer infrastructure may include compute nodes, which are the individual servers, machines, processors, or processor cores that perform the actual computing operations. Each node may contain one or multiple CPUs and may be connected to other nodes via high-speed interconnects such as InfiniBand or Ethernet. Optionally, compute nodes may additionally have GPUs, or specialized accelerators. It is also possible that a single multi-core CPU or each individual core forms a compute node. Preferably, a modular supercomputer infrastructure includes specialized accelerator nodes equipped with GPUs, or specialized accelerators. Further it comprises an interconnect fabric, which is the network that connects the compute nodes and the specialized accelerator nodes together, allowing them to communicate and share data. High-speed interconnects are preferably used to minimize latency and maximize bandwidth, enabling efficient parallel processing. Furthermore, a modular supercomputer infrastructure may include storage systems, management software, such as job scheduling software, cluster management software, and system monitoring tools, and application software, e.g., software implementing AI functions.

The initial training dataset contains technical and or scientific publications, such as journal articles, conference proceedings, technical reports, books, patents, theses and dissertations, standards. The publication may be stored as plain text, or in other machine-readable format, such as HTML (Hypertext Markup Language), XML (Extensible Markup Language), JSON (JavaScript Object Notation), etc.

The algorithms database contains and provides an assembly of algorithms to be applied by the system for feature engineering and machine and deep learning purposes to analyze and evaluate the data of the initial training dataset. Such algorithms may include algorithms that could be used to analyze and evaluate the data in the initial training dataset, such as Linear Regression, Logistic Regression, Linear Discriminant Analysis, Classification and Regression Trees, Naive Bayes, K-Nearest Neighbors (KNN), Learning Vector Quantization (LVQ), Support Vector Machines (SVM), Random Forest, Boosting, AdaBoost, Convolutional Neural Networks (CNNs), Recurrent Neural Networks (RNNs) or transformer models. Further it may include algorithms used to automatically generate technical solutions, especially inventive solutions as further describe below.

The invention module is adapted to track solutions provided by models trained on the initial training dataset and its expansions, and for managing the activities of the infrastructure. The system manager is adapted to input requests of a user for requesting the system to provide solutions in response to such requests. The invention algorithm is adapted to check and test the plausibility of the findings.

The invention module, the system manager and result classifier may be implemented in hardware and/or software, they may be realized individually or combined by using one or more of the compute nodes of the modular supercomputing infrastructure. Alternatively, the invention module, the system manager, and result classifier may be realized by using a micro-processor, a microcontroller, a programmable logic controller (PLC), a field programmable gate array (FPGA), or a single-board computer (SBC). When using such types of hardware, it could be advantageous to employ model compression to achieve a model that is simplified from the original without significantly diminished accuracy, e.g., by pruning, quantization, low-rank approximation and sparsity, knowledge distillation, neural Architecture Search (NAS).

Preferably, a result simulator is adapted to run simulation algorithms provided by a deep learning simulation algorithms database. The result simulator may use simulation algorithms based on trained deep learning surrogate simulators to simulate complex systems, such as generative adversarial networks (GANs) or diffusion models, which are a type of deep learning algorithms that can generate highly realistic simulations of complex systems, deep recurrent neural networks (RNNs) or Neural ODE and PDEs, which can be used to simulate dynamic systems by predicting the future state of a system based on its current state and past inputs, or convolutional neural networks (CNNs) and transformers, which can be used to process high dimensional signals like images, audio, video or generic sequences to create compact representations, or embeddings, for fast dynamic system simulations. Other classical simulation techniques used in engineering may also be employed, such as Finite Element Analysis (FEA), Computational Fluid Dynamics (CFD), Discrete Event Simulation (DES), or Monte Carlo Simulation (MCS). Further differentiable simulators that can be co-adapted during learning can be employed as well.

Advantageously, the holistic computing system further comprises a grant manager which is adapted to receive corresponding legal requirements for patenting the findings from a legal database and matching the findings with the help of a grant algorithm in view of the prior art from the initial training dataset. The grant manager may be realized by using one or more of the compute nodes of the modular supercomputing infrastructure. Alternatively, the grant manager may be realized by using a micro-processor, a microcontroller, a programmable logic controller (PLC), a field programmable gate array (FPGA), or a single-board computer (SBC).

Preferably, the grant module further comprises a patent drafting algorithm adapted to draft predefined documents of a patent application. The patent drafting algorithm may advantageously include drafting of a brief and descriptive title that summarizes the nature of the invention, a brief description of the technical field in which the invention falls, a description of the state of the art and the problems or shortcomings of the prior art that the invention seeks to address, a brief summary of the invention and its technical features, a detailed description of the invention and one or more embodiments, one or more drawings or diagrams that illustrate the invention and its technical features, a set of claims that define the legal scope of the invention, and an abstract. Advantageously, the drafting algorithm is decoupled from the inventor module, so that learning of both modules can be done independently.

Advantageously, the grant module is adapted to file a patent application with a patent office. This might include the step of registering for electronic filing, which is typically only required once. For each application, the grant module is adapted to submit the application, which includes using an electronic filing system to upload and submit the patent application and any accompanying documents. Optionally, the grant module may also be adapted to pay filing fees, e.g., by use of a credit or debit card or by wire transfer. To enable the grant module to file patent applications, the grant module preferably includes communications means, such an ethernet port, which allows for wired internet connectivity, or a Wi-Fi adapter, which allows for wireless internet connectivity, or a cellular adapter, which allows for mobile internet connectivity.

One may assume that with the advent of the Inventer, the entire concept of patenting may come to an end. The basic idea of awarding patents by the authorities for “special” performances of HUMAN beings' rests on an assumption that above-average technical solutions should be honored and thus motivated and triggered by such awards like a temporary monopoly. In essence the patent system of such rewards relies in the end on a comparison form human to human. However, it seems to be inappropriate to provide the Inventer with tools for solutions human beings do not have and then compare the Inventer's solutions with standards developed for the human-to-human comparison. Several Inventers may come up with different technical solutions and there might be linear ideas for “patenting”, comparing the Inventer's solutions with each other. We however believe that with the Inventer a whole different new and unfathomed world emerges which will have, to a very large extend to develop its own new unique unheard-of standards. For the time being, we refer to the existing standards from canonical patenting, but do not want to be limited to the existing standards.

Advantageously, the initial training dataset is a self-learning database and contains information from scientific and technical articles, patents, books, existing databases of all kinds of accessible data sources. A self-learning database is a type of database that is designed to continuously improve its performance and accuracy over time, without the need for human intervention. This may be achieved, e.g., by using active learning algorithms that analyze existing and arriving data and identify data that can be used to improve the performance or data that should be removed to avoid performance loss, when training corresponding models.

Preferably, the modular supercomputer infrastructure comprises a plurality of first computing elements configured to perform arithmetic calculations with a first precision, one or more second computing elements configured to perform arithmetic calculations with a second precision. The term precision refers to the level of detail or accuracy in the calculation. It is a measure of how many significant digits are used to represent the result of a calculation. For example, if a computer is using 16 bits to represent a number, it can represent a maximum of 2\hat{ }16 (65,536 ) different integer values. However, the actual number of significant digits that can be represented as floating point number depends on the specific encoding method used and the range of values being represented. For example, a 32-bit floating point number typically has 24 bits for the mantissa, which allows for about 7 decimal digits of precision.

Advantageously, the plurality of first computing elements comprises at least one of a group of components, the group comprising: a processing node, a multi-core processor, a general-purpose central processing unit, a scalar processor, a multi-scalar processor, a processor core, a system-on-chip, a computer, a workstation.

Preferably, the one or more second computing elements comprise at least one of a group of components, the group comprising: GPU, FPU, FPGA, ASIC, neural processing unit, tensor processing unit, parallel processor. A GPU, or Graphics Processing Unit, is a specialized type of processor which is highly parallelized and can perform many calculations simultaneously, making them well-suited for tasks that require large amounts of data to be processed quickly. An FPU, or Floating-Point Unit, is a specialized hardware component that is designed to perform floating-point arithmetic operations, which involve decimal numbers with a varying number of digits before and after the decimal point. An FPGA, or Field-Programmable Gate Array, is a type of integrated circuit that can be programmed and reprogrammed to perform a wide range of digital logic functions. An ASIC, or Application-Specific Integrated Circuit, is a type of integrated circuit that is designed for a specific application or purpose. A Neural Processing Unit (NPU) is a specialized hardware accelerator designed to perform the complex calculations required for artificial neural networks, the foundation of deep learning. NPUs are optimized for the matrix operations that underpin neural networks, enabling faster and more efficient training and inference. A Tensor Processing Unit (TPU) is a specialized application-specific integrated circuit (ASIC) for machine learning workloads. TPUs are designed to accelerate the computation of tensor operations, which are fundamental to many deep learning algorithms. A parallel processor is a type of computer architecture that allows multiple instructions or calculations to be executed simultaneously, or in parallel.

Advantageously, the modular supercomputer infrastructure comprises at least one quantum computing element, which may be equipped with one or more quantum computers of any kind/provenience of qubits, including quantum annealers as provided by D-Wave Inc., Canada, or quantum simulators as provided by Pasqal, Massy, France.

Preferably, the system manager is configured to assign a first part of a computational task to one or more of said plurality of first computing elements and a second part of the computational task to one of the one or more second computing elements. The system manager may use static allocation, according to which the assignment of processes to computing elements is made at the beginning of the computation and remains fixed throughout the execution, or dynamic allocation, according to which the assignment of processes to computing elements may change during the computation, based on current availability and workload, or a combination of both.

Advantageously, the computational task is a task to perform training or inference of a deep neural network. Such tasks may include training generative models, which is training of a neural network to generate new content, such as images, videos, or text, based on patterns learned from existing data, or training a language model for natural language processing involving training a neural network to understand and process human language, or training a vision model, involving training a neural network to identify objects or features within an image to perform various tasks like image classification, and other pertinent modalities.

Further provided is a method for making and providing new technical and scientific solutions by a holistic computing system. As described above, the holistic computing system comprising an initial training dataset and expanding self-learning database containing technical and or scientific publications. Further it may include an AI function, such as those provided by transformers like GPT-3 or BERT.

In a first step, a user request is received, providing control information to control the holistic computing system to generate one or more innovative solutions in a targeted manner. The user request contains one or more information items of a group of information items, the group of information items comprising: a description of a subject area in which a solution is to be determined, a description of existing solutions, a description of the problems caused by these existing solutions and a description of a specific task.

Subsequently, the content of the user request is analyzed. Preferably, it is analyzed whether one or more of the named information items are present and which ones. Further, the content of each information item may be analyzed. This may include determining the length of each provided information item. If the length is below a pre-determined threshold, it may be determined that the information item is insufficient. In such a case it could be advantageous, to use the AI function and other provided information elements, to create or supplement the missing or insufficient information element.

In a further step the user request is abstracted. The AI function is advantageously used to create an abstraction from the user request by utilizing natural language processing (NLP) techniques.

Preferably, abstractive summarization is used, which involves generating new sentences to summarize the text. For this approach, advantageously AI language models based on transformer networks, such as GPT, BERT, T5, LLAMA, are used.

The information related to the abstracted user request can be also used for retrieval from the self-learning database. This is either done with directly querying the database, or with the help of the AI function, for example by employing semantic search or by using retrieval-augmented pre-trained models. Semantic search is a search technique that uses AI to understand the meaning of a query and the context in which it is being used, rather than relying solely on keyword matching. Advantageously, retrieval-augmented models are used, which are a class of AI models that use a combination of retrieval and generation methods to generate responses to queries or prompts. These models incorporate a pre-defined set of retrieved knowledge sources or passages that can be used to help generate more accurate and informative responses. Retrieval-augmented models can learn to access and retrieve items from any external source to aid task solving during inference.

Subsequently, the AI function is fine-tuned, or inference is conditioned using the information related to the abstracted user request retrieved from the self-learning database. Fine-tuning is a technique used in artificial intelligence (AI) to adapt a pre-trained model to a specific task or domain. In the context of AI transformer models, such as BERT, GPT-3, and T5, fine-tuning involves taking a pre-trained model and training it on a new dataset that is specific to a particular task. Fine-tuning allows the model to adapt to the specific language patterns and structures of the new dataset, which can improve its performance on the task at hand. Conditioning does not require learning and can use the retrieved information to perform zero-shot inference (also termed as in-context learning) Then, the fine-tuned or retrieval conditioned AI function is used to generate a solution based on the information item or items of the user request. This is preferably done by having the system automatically constructing a prompt for an AI transformer model providing a specific task or goal for the model to achieve, along with any relevant context or information necessary to complete the task. In the present case, the prompt requests a list of solutions in the described subject area that differ from the existing solutions, avoid the problems caused by the existing solutions, and solve the specified tasks.

Then, i.e., in the present case, after the prompt has been sent to the AI function, information about the solution generated by using the fine-tuned or conditioned AI function is retrieved. This is either done with directly querying the database, or via or with the help of the AI function, for example by employing semantic search. Semantic search is a search technique that uses AI to understand the meaning of a query and the context in which it is being used, rather than relying solely on keyword matching.

Once the solution generated by using the fine-tuned or conditioned AI function is available, the degree of similarity between that solution and the information retrieved from the self-learning database related to the solution generated by using the fine-tuned AI function is determined. The degree of similarity may be determined by cosine similarity, topic modeling, or text summarization.

In case the degree of similarity is over a pre-determined threshold, the step of further fine-tuning the fine-tuned AI function is performed by using the information related to the solution generated by using the fine-tuned AI function, and repeating the previous steps based on the further fine-tuned AI function: Using the further fine-tuned AI function to generate a solution based on the information item or items of the user request, retrieving from the initial training dataset information related to the solution generated by using the fine-tuned AI function, and determining the degree of similarity between the solution generated by using the fine-tuned AI function and the information retrieved from the initial training dataset related to the solution generated by using the fine-tuned AI function.

Finally, the generated solution is output, either to a user or for further processing in as described above regarding the holistic computing system for making inventions.

Preferred embodiments of the Inventer are described by way of example with reference to the accompanying drawing:

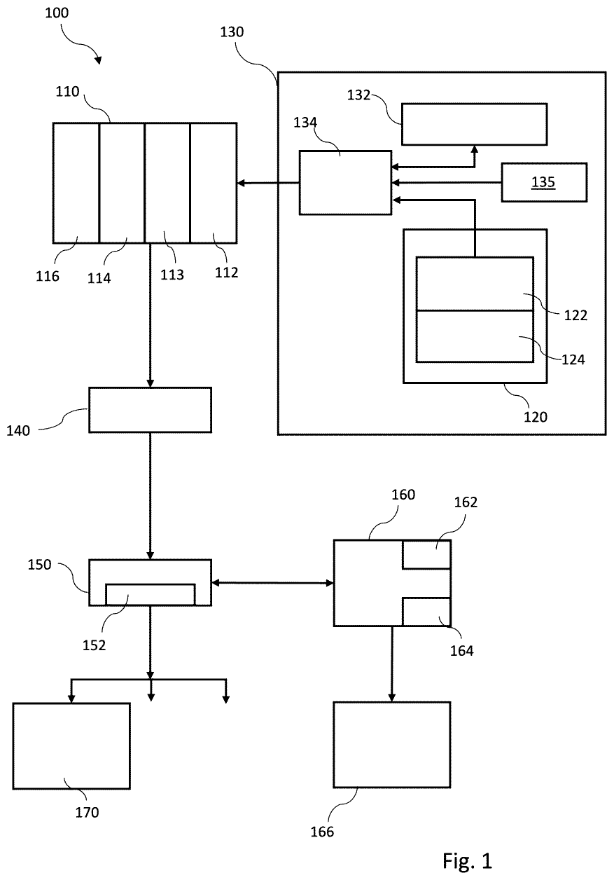

FIG. 1 illustrates an example computing system for making and providing new technical solutions, and or inventions.

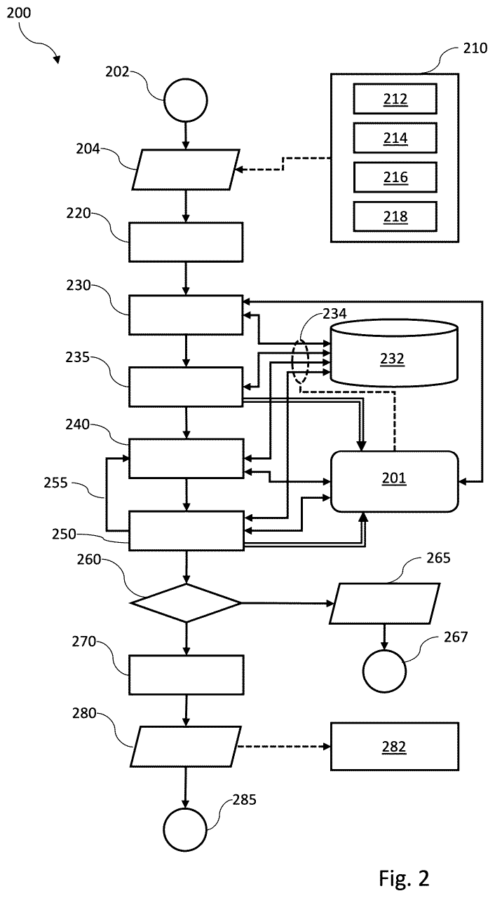

FIG. 2 shows a flowchart of a refinement of the algorithm according to the invention.

FIG. 1 depicts a computing system for making inventions 100, also referred to as holistic computing system. The computing system for making inventions 100 comprises a supercomputer infrastructure 110 with a plurality of computing elements constructed according to the concept of the MSA. In the shown embodiment, the infrastructure 110 comprises elements of different processor design, typically multi-core, and many-core processors. In the provided example, it comprises one or more high precision elements 112, one or more mixed precision elements 113, one or more low precision elements 114, and one or more Quantum computing elements 116, and neuromorphic and other processor elements (not shown). The high precision elements 112 may be equipped with a plurality of CPUs, the low precision elements 114 may be equipped with a plurality of GPUs and the Quantum computing elements 116 may be equipped with one or more quantum computers of any kind/provenience of qubits, including quantum annealers as provided by D-Wave Inc., Canada, or quantum simulators as provided by Pasqal, Massy, France. Technologies, following the Modular Supercomputing Architecture, specifying the use of low, mixed, and high precision processors and their use are disclosed in the EP application 23 162 889.2, which is fully incorporated herein.

The computing system 100 for making and providing new technical and scientific solutions, also inventions, further comprises a database 120 and an initial training dataset of an existing art, also referred to as prior art database or first database 122, which contains existing and/or prior art references. The existing art references may be, inter alia, patent publications and non-patent literature such as scientific publications, technical publications, technical or scientific handbooks or manuals, journals, magazines, product descriptions, technical white papers, internet publications, or any user knowledge. The existing art references contained in the first database 122 may be categorized by their technical and/or scientific field. One type of categorization, especially for patent publications, may be patent classifications such as IPC or CPC classifications. The references may be available, for example, in text format combined with digital picture format, as scanned and OCR-ed Text or entirely in digital pixel form, especially for scanned documents created before the digital era, or in any other information storage format. These words or pixel representations will be converted to tokens embeddings as described above.

In one aspect of the invention, the existing art is also or alternatively ordered and stored in its inherent logical and technical context, in which it is embedded. Typically, technical disclosures and scientific disclosures, articles, patents, and the like are presented in the context of their technical environment.

They typically refer to other disclosures, descriptions relevant for the document in question, which in turn reference further documents, and so on, creating a tree of references. Preferably, the database makes use of such inherent contextual disclosure structure, also for deep learning, and emulates the same. The databases are updated continuously to keep them always up to date with the latest developments.

A second dataset, a legal database 124, may contain decisions on the grant, refusal or revocation of patents, and the like from IP offices or courts. It may further include the corresponding office or court files. The legal database 124 may also contain secondary literature like Patent Office publications like MPEP published by the USPTO or Guidelines published by the EPO, collections of case law and commentaries on patent law. The entries in the legal database 124 may be classified by jurisdictions and have further tags such as instance of the decision. The new system is capable updating continuously its databases in all aspects like the ones just described and to include the updated database in its continuous learning process.

The computing system is now explained as a system for making inventions, the Inventer. It is well understood that any useful and plausible new result is welcome, also if not meeting the legal requirements for patenting. In this sense, without limitation, the system 100 further comprises an invention module 130, featuring high I/O capabilities, comprising invention algorithms 132. The invention module 130 is adapted to make use of the infrastructure 110 with its different processing elements. Alternatively, the invention module 130 may be physically and or functionally split into a set of sub-modules (not shown), each being adapted to make use of one or more of the different processing elements, such as 112, 113, 114, 116, of the infrastructure 110. The invention algorithm 132 may be a mix of various deep learning algorithms, a self-learning procedure in the invention module 130, and may be trained on basis of the documents of the existing art database, i.e., the first database 122, and their contextual interleaving. The existing technical and scientific context in which all prior and existing art is naturally organized, is maintained, and further combined and further organized along further developing plausibility considerations.

The invention algorithm 132 is pre-trained using one or more general existing language models based on transformer architecture, like GPT-3, BERT or T5. The pre-trained model, invention algorithm 132, is refined continuously based on the databases 120 and 122 as well as 124. This refinement is carried out by token-wise training steps to capture text and figure modalities of the patent and other documents, text, and figures. Advantageously, a language vision model that deal with sequences of interleaved text images is employed, like Flamingo. The training of the invention algorithm 132 developed by Inventer can either be universal or specialized in specific technical fields such as electrical engineering, mechanical engineering, physics, computer science, chemistry, life sciences or biology. These specializations are achieved through a process called macro-refinements, which involves recognizing the unique characteristics of each technical field and executing specific training steps on the tokens.

To provide more detailed examples, let's take the field of electrical engineering as an example. The invention algorithm may undergo a macro-refinement process to identify the unique characteristics of electrical engineering. This could involve analyzing the specific terminology, equations, and principles that are commonly used in the field of electrical engineering. The algorithm may also be trained on a dataset that contains examples of electrical engineering inventions to help it better understand the unique challenges and requirements of this field.

Similarly, in the field of chemistry, the invention algorithm may be macro-refined to recognize the unique characteristics of the chemical sciences. This could involve training the algorithm to recognize specific chemical structures, reactions, and properties, as well as the language used to describe them. The algorithm may also be trained on a dataset of chemical inventions to help it better understand the challenges and opportunities in this field.

In the field of life sciences, the invention algorithm may be macro-refined to recognize the unique characteristics of biology, genetics, and other related fields. This could involve training the algorithm to recognize specific biological structures, processes, and functions, as well as the language used to describe them. The algorithm may also be trained on a dataset of biological inventions to help it better understand the challenges and opportunities in this field.

The training of the invention algorithm 132 of the Inventer is performed preferably on the modular supercomputer infrastructure 110, taking advantage of the fast I/O capabilities of the respective modules, and may be continuously further trained and optimized with new entries in the existing art database. In case, the invention module 130 is physically and or functionally split into a set of sub-modules (not shown), each sub-module hosts a self-learning algorithm, as described, each of which is performed on one or more of the different processing elements, such as 112, 113, 114, 116, of the infrastructure 110. The different modules of the infrastructure 110 may be used according to their inherent technical possibilities. Depending on the required precision, the text parts of the training may be executed on a 32-bit module, while the picture parts might be trained on lower precision modules, with respect to the effectiveness one wants to achieve. Other appropriate digital modules may be engaged to do plausibility tests and relate it to intermittent simulations. A Quantum Module may be used to search and define in advance all possible meaningful combinations of existing art to find combinations or families of combinations that are technical plausible in the captioned field.

Advantageously, the system and the invention algorithm are designed to be interconnected and coupled so that it can continuously update itself in the sense of “Learning-to-Learn.” This means that the system is capable of iterative processes on the go, which enables it to learn and improve over time. For example, a machine learning system that uses reinforcement learning to play a video game can be designed to continuously update itself as it plays the game. As it plays the game, it can learn from its mistakes and improve its performance on subsequent rounds. The system can be interconnected and coupled in a way that allows it to adapt its strategies and improve its performance over time. The training of the invention algorithm 132 may be universal or, alternatively, focused and limited to specific technical field such as electrical engineering, mechanical engineering, physics, computer science, chemistry, life sciences or biology. In one embodiment, the invention algorithm 132 may be a neural network e.g., a transformer trained by deep learning techniques, such as GPT-3, BERT, T5, FLAMINGO, etc.

A service module 134 is provided within the invention module 130 of the Inventer. The service module 134 is adapted to perform the invention algorithm 132 and access the database 120.

Particularly, the service module 134 enables the invention algorithm 132 to retrieve technical teachings based on the known technologies disclosed in the existing art database, namely the first database 122. The new technical teachings may, in one embodiment, be obtained by the invention algorithm 132 combining aspects of known technical teachings from the first database 122. Additionally, or alternatively, the self-learning algorithm 132 may evaluate developments in one technical field and adapt those developments to different and non-similar technical fields in the sense of transfer learning, i.e., knowledge is gained while solving one problem and applied to a different but related problem, or it performs a prediction of future developments in a specific technical field based on previous developments in the field. Algorithm 132 of the Inventer can be executed after training on a module with cloud service access capabilities in the inference mode to allow for user inquiries in a scalable manner.

Advantageously, the invention algorithm 132 uses the background section of patent publications to analyze the disadvantages and identify potential solutions. The algorithm aims to improve known technical solutions in a particular technical field by identifying common problems and evaluating proposed solutions based on technical or cost aspects.

For example, if the background section of a patent publication in the field of transportation describes the problem of high fuel consumption in cars, the algorithm may analyze similar problems in other patent publications in the same field. By identifying an accumulation of similar problems, the algorithm may determine that there is an intrinsic need for improvements in the field of transportation related to fuel efficiency.

Overall, the invention algorithm aims to identify common problems in a technical field. By doing so, the algorithm can help identify potential improvements in existing solutions and identify new solutions to existing problems in various technical fields.

In one embodiment, the service module 134 is adapted to retrieve a user request 135, such as a new technical teaching, and to make it available to the invention algorithm 132. Such a user request 135 may define a technical problem to be solved, such as a specific technical component or machine for which the new technical teaching should be provided. The request can be provided in form of text, pictures, or other information types. In a specific but arbitrarily chosen example embodiment the user request may be the need for a novel design of a supercritical airfoil upon which at least one design of a supercritical airfoil is provided.

The invention algorithm 132 is preferably adapted to select one or more plausible solutions to the technical problem based on predetermined criteria selected from technical, physical and/or social assumptions.

The elected solutions are, in some embodiments, subsequently handed over to a simulation module 140, also referred to as result simulator. The simulation module 140 will conduct simulations of the technical solutions. These simulations may confirm the technical feasibility of the solution. In the embodiment of the supercritical wing, the simulations may include CFD (Computational Fluid Dynamics) simulations to validate the uplift of the wing and flow break criterion or FEM (finite element method) simulations for validating the durability of the component. If the feasibility of the technical solutions is not confirmed, the solution is discarded and the next solution is selected. The process can also be performed in parallel on several solutions at the same time. The system is also well adapted to further combine solutions and then do the simulation on such results.

If the simulation module 140 is passed with positive results, the technical solution is forwarded to a result classifier module 150. In the result classifier module 150, the solution is evaluated with respect to its plausibility and probability of patenting success for further processing and deployed for a subsequent use.

In one embodiment, in which the technical teaching is classified for filing of a patent application, it is forwarded to a grant module 160.

The technical teaching is evaluated in a grant module 160 as regards to patentability, i.e., novelty and inventive step. Therefore, the grant module 160 contains a grant algorithm 162 which may be a self-learning algorithm with following capabilities. First, the grant algorithm 162 evaluates the technical teaching in the light of the existing art database, i.e., the first database 122. This may include defining the closest existing art as well as relevant prior art. Second, the grant algorithm 162 further has access to the legal database 124. The self-learning algorithm 162 adjusts its criteria for novelty and inventive step based on the information from the legal database 124 and applies the criteria on the technical teaching to be evaluated. This could be implemented by first collecting and organizing an existing art database that the self-learning algorithm can refer to while evaluating technical teaching. The database can include information about patents, publications, and other technical documentation related to the field of interest. Then, the self-learning algorithm can be configured to define search and analysis criteria based on the type of technical teaching to be evaluated. The criteria can include keywords, algorithms, and techniques for analyzing and categorizing information from the existing art database. The self-learning algorithm may further be configured to have access to a legal database that includes information about relevant laws, regulations, and legal precedents related to the field of interest. As a self-learning algorithm, the algorithm is configured to adjust its criteria for novelty and inventive step based on the information from the legal and technical databases. This can be done by analyzing legal precedents and applying the criteria to the technical teaching being evaluated. Once the criteria have been defined and adjusted based on the legal database, the self-learning algorithm applies the criteria to the technical teaching being evaluated. The system can compare the technical teaching to the closest existing art and relevant prior art, as well as evaluate its novelty and inventive step based on legal and technical criteria.

The grant algorithm 162 may provide different criteria for novelty and inventive step for each jurisdiction. The grant algorithm 162 may be adapted to provide an abstracted technical teaching with its condensed key features which are matched to the patentability requirements in view of the prior art. In case of a positive evaluation of the technical teaching as regards to patentability, the grant algorithm may in one embodiment forward the abstracted technical teaching to a drafting algorithm 164. The drafting algorithm 164 may be trained to define the abstracted technical teaching in a patent claim-like format. To train the drafting algorithm 164, a large and diverse dataset of patent applications is advantageous. The dataset should contain examples of successful and unsuccessful patent applications, as well as different types of patents from various fields. Before the dataset can be used for training, it needs to be pre-processed to remove any noise and inconsistencies. This includes tasks such as text normalization, tokenization, and stemming. Once the data is pre-processed, features can be extracted from the patent text. This can include both linguistic features, such as part-of-speech tags, and domain-specific features, such as technical terms and concepts. The drafting algorithm 164 can be trained using supervised learning algorithms, such as neural networks or decision trees. The system is trained to predict the probability of a given patent application being successful based on the features extracted from the text. After training, the system is preferably validated using a separate test dataset to ensure it is accurately predicting patent success. As the system drafts more patents and receives feedback from patent attorneys and patent offices, it can continuously learn and improve its performance through a process of iterative improvement.

Additionally, in a further step, all mandatory parts and optional parts of a patent application may be provided. The patent drafting algorithm 164 may be trained using the examples in the existing art, preferably of patent applications and patents in the prior art database 122. The documents for a patent application are generated by the drafting algorithm 164 may be submitted as a patent application with the patent office 166.

If the result of the patentability evaluation by the grant algorithm 162 in the grant module 160 is negative, a loop is generated by amending and/or redrafting redefining the technical solution. This may be implemented by providing the grant algorithm 162 with a feedback mechanism that allows feedback on the quality of the generated patent claims. This feedback can be used to refine the grant algorithm 162 patent drafting process, such as by adjusting the weight of certain features or changing the rules for generating patent claims. The grant algorithm 162 may be designed to continuously learn and improve its performance over time. For example, it could use a reinforcement learning algorithm to adjust its patent drafting process based on feedback from legal experts or based on its own performance in generating patent claims. Alternatively, the grant algorithm 162 could include a rule-based system that defines a set of rules for generating patent claims. If the grant algorithm determines that a patent claim is not patentable, the rule-based system could be invoked to generate a new patent that addresses the issues identified by the grant algorithm.

If the redefinition of the technical solution claims is not successful at all, i.e., no patentable solution may be defined, a different technical solution may be elected.

The result classifier module 150 may additionally classify the technical solution for production. Therefore, the classifier module 150 comprises a design algorithm 152 adapted to transfer the technical solution into a design ready for production. For this, the design algorithm 152 may be adapted to acquire data on the technical solution from the previous steps, such as schematics, diagrams, and other relevant information. This data could be obtained from a variety of sources, including databases, technical documentation. Once the data is acquired, the design algorithm 152 pre-processes the data to ensure that it is in a suitable format for the design process. This might involve cleaning and filtering the data, as well as performing feature extraction to identify key design parameters. The design algorithm 152 would use the pre-processed data to generate a design for production. This might involve using machine learning algorithms to identify patterns in the data and generate a design that meets specific constraints and objectives. For example, the design algorithm 152 might generate a design that optimizes certain performance metrics or minimizes production costs. Once the design is generated, the design algorithm 152 evaluates it to ensure that it meets certain quality standards and is suitable for production. This might involve using simulation or other testing methods to evaluate the design's performance under different conditions. If the initial design does not meet the desired quality standards or performance metrics, the design algorithm 152 is adapted to refine the design. This might involve iterating on the design generation and evaluation steps until a suitable design is identified. Once a suitable design is identified, the design algorithm 152 transfers the design to a production system. This preferably involves generating machine-readable design and manufacturing instructions for the production process.

The design algorithm 152 may then forward the design and manufacturing instructions such as CAM data to the manufacturing facility 170, where the CAM data are used to operate the manufacturing tools. Other uses of the design are envisaged, e.g., for communication, for evaluation, for documentation, for training, or for marketing, as indicated by the other arrows extending from the result classifier module 150.

In the above description of a system for generating inventions, a straightforward process of generating an invention, which may be executed on a computing machine, is described. However, in case that at one point of the process a negative result such as a non-plausible or a non-durable solution is reached, the process opens a loop and at least the last step, e.g., the process on the last module, is repeated. Based on the negative result, the module generating the negative result may open a loop with only a repetition of the last process or a repetition of several previous processes. In one embodiment, a repetition of the complete process after the user requests 135 may be performed. Advantageously, a predetermined number of iterations is specified, and the loop is exited after that number of iterations has been reached.

Alternatively, or additionally, a reset or re-training of one or more self-learning algorithms may be triggered in case no plausible results are delivered.

The part of the invention related to patent matters is only explained to illustrate the invention, but its usefulness is also obvious without the legal point of view to patenting.

FIG. 2 shows a flowchart of a refinement of the algorithm according to the invention as provided in the invention module 130 of the embodiment of FIG. 1. As described with reference to FIG. 1, the service module 134 is provided within the invention module 130 of the Inventer. The service module 134 is adapted to perform the invention algorithm 132, to access the database 120, and may be adapted to retrieve a user request 135. In the following example of an invention module, and particularly an invention algorithm 132, a user request 135 is provided to control the invention module to generate a novel solution for a particular problem or task.

As to FIG. 2, the invention algorithm 200 determines the data and control flow of the invention module by controlling the receipt of user requests, the retrieval of information from databases, the access to an AI function 201, such as those provided by transformers such as GPT-3 or BERT, the processing of AI function's outputs, etc., as described in more detail below.

In the present example, processing begins at point 202 with a first activity 204, namely the reception of a user query 210. The user query 210 preferably contains specific information that is intended to enable the computing system for making inventions to output suitable and novel solutions. By providing this specific information, a context is established so that particularly the AI function 201 is enabled to generate an output for further processing.

Preferably, the user request 210 contains a description of the subject area 212 in which a solution is sought. If applicable, the description of the subject area 212 may also include a description of existing solutions 214 in the subject area. When a description of existing solutions 214 is provided it is advantageous to also provide a description of the problems caused by these existing solutions 216. Alternatively, or additionally, the user request 210 may also contain a description of a specific task 218 to be solved. The user request 210 should include—implicitly or explicitly—indications, marking the respective descriptions 212, 214, 216 and 218, so that individual descriptions such as the description of a specific task 218 can be accessed for further processing. In a preferred example, the user request 210 is provided in text form. However, other forms which are machine readable are also possible, such as a tokenized form, namely a form adapted for further processing by the AI function 201, as “tag-length-value” (TLV), Extensible Markup Language (XML), JavaScript Object Notation (JSON).

In a subsequent activity 220, the submitted user request 210 is analyzed. It is determined whether any of the descriptions 212, 214, 216 and 218 are present. Depending on which information is present, the processing is handled differently.

It has been found that the result of the invention algorithm is particularly good when information on all four areas, subject area 212, existing solutions 214, problems 216 and specific tasks 218 are included. However, this does not mean that all information must always be provided.

In activity 230, the invention algorithm uses the available resources, in particular the database 232, the AI function 201 and predetermined information, to supplement information about the areas that were not specified in the user request 210. This includes expanding the areas that were specified but whose description is insufficient, which can for example be determined by the length. So, if a description is shorter that a predetermined length, it is treated as insufficient.

Predetermined information is particularly used in case that the description of a specific task 218 was not provided. In such a case, the description of the task 218 is replaced by one or more optimizing criteria from a group of optimizing criteria, the group comprising: efficiency, reliability, scalability, accessibility, compatibility, security, sustainability, affordability. Advantageously, the criteria are measured during the training process. This might involve using a validation set or test set to evaluate the model's performance on a subset of the data. The measured criteria can be used to derive reward scores that reflect the model's performance on the task. For example, if the criteria are efficiency and reliability, the reward score might be a weighted combination of these two metrics. The reward scores can be used as learning signals to guide the training process. For example, the reward score might be used to adjust the weights of the neural network during backpropagation, or to modify the parameters of a reinforcement learning algorithm.

In this context, efficiency means that the innovation should fulfil its function as efficiently as possible, using as few resources as possible (e.g., energy, time, material) while still achieving the desired result. Reliability means that the innovation is dependable and performs its intended function without failures, errors, or breakdowns. Scalability means that the innovation must be able to grow and cope with increased usage without significant performance degradation. Accessibility means that the innovation must be user-friendly, easily accessible, and available to a wide range of users, regardless of their technical knowledge and skills. Compatibility means that the innovation must be compatible with existing technologies, systems and infrastructures and not cause conflicts or disruptions in existing systems. Security requires that the innovation be equipped with robust security measures to protect sensitive data and systems from potential threats such as cyber-attacks, malware, or unauthorized access. Sustainability means that the innovation is environmentally sound, uses renewable resources, minimizes waste, and reduces its carbon footprint. And affordability means that the innovation must be low-cost, affordable, and accessible to a wide range of users without compromising on quality or performance.

If the description of the subject area 212 is not provided, the AI function 201 may be used to generate this information. In the present example, the AI function 201 is provided by a generative AI system that accepts a prompt in the form of a text and provides a completion in the form of a text. To retrieve from an AI function 201 information about a subject area based on an existing solution, and or a description of a problem, and or a specific task, the invention algorithm performs the following steps. First, a prompt is created that contains all or part of the information specified in the user request 210. Further, the prompt includes an indication that the subject area is to be determined based on the specified information. The query is then forwarded to the AI function 201 and the result provided by the AI system is retrieved. The retrieved result describes the subject area based on the specified information and is then used as it would have been specified in user request 210.

Alternatively, it is also possible to select a subset of the information provided by the user query 210 as the basis for the query to the AI function 201 about the subject area and use the other information in a subsequent query to the AI function 201 to refine the result. The other information may alternatively be used to have the AI function 201 check its own answer to see if it matches the additional information provided. If it does not, the algorithm prompts the AI function 201 to revise its previous answer to match the additional information. These additional steps can be used to improve the result provided by the AI function 201. This may be realized by adapting the AI function 201 to automatically use other additional information to verify its answer. Then, it can use it to validate its original answer. For example, if the additional information confirms the original answer, the AI function 201 can be confident of its answer. On the other hand, if the other information contradicts the original answer, then the AI system can revise its answer or provide a different explanation. In this way, an AI system can use a subset of information to generate an initial answer, and then use additional information to check and validate that answer. This approach can help to improve the accuracy and reliability of the AI system's responses.

The selection of the subset of information may be done randomly or pseudo randomly or based on a predetermined priority list.

Correspondingly, the AI function 201 may be used to determine the problems caused by existing solutions if a respective description of the problems caused by existing solutions 216 is absent from the user request 210 or if it should be expanded. In such a case, the invention algorithm may generate a prompt, i.e., a piece of text or code that is used to instruct a language model or other AI system to generate a response or output, requesting a list of drawbacks from existing solutions provided in the user request 210. The invention algorithm may additionally further specify one or more from a group of categories of problems that can be present in a technical solution, the group comprising: performance problems, security problems, usability problems, reliability problems, compatibility problems, maintainability problems, cost problems.

Performance problems include issues such as slow processing times, high latency, or insufficient scalability to handle large amounts of data or users. Security problems include vulnerabilities that allow unauthorized access, data breaches, or other security threats that compromise the confidentiality, integrity, or availability of the system. Usability problems can include difficulties with user interfaces, navigation, or accessibility, which can make the system difficult to use or understand for certain users. Reliability problems can include issues such as frequent downtime, crashes, or errors that prevent the system from functioning as intended. Compatibility problems include issues with integrating the system with other systems, platforms, or devices, or compatibility issues with different versions of software or hardware. Maintainability problems include issues such as complex or poorly organized code, lack of documentation, or difficulties in updating or maintaining the system over time. Cost problems include issues such as high infrastructure or development costs, inefficient use of resources, or difficulties in estimating or managing project budgets.

Based on these categories of problems the invention algorithm may query the AI function 201, whether the existing solution has, e.g., reliability problems and what they are. The result of such an enquiry is used in the subsequent steps to generate a solution that does not have such a problem. This may be achieved by using a constraint-based optimization approach, where the system is programmed to follow certain rules or constraints that ensure that the solution meets certain criteria. For example, if the problem to be avoided is that a certain chemical is toxic to humans, the system could be designed to only generate solutions that do not include that chemical. Another approach is to use a generative adversarial network (GAN), which is a type of machine learning algorithm that uses two networks to generate a solution. The first network generates a solution, and the second network evaluates the solution to see if it meets certain criteria or avoids certain problems. The two networks are then trained together to improve the quality of the generated solutions over time. A third approach is to use a genetic algorithm, which is a type of optimization algorithm that mimics the process of natural selection. The system generates a set of potential solutions, and then uses a fitness function to evaluate each solution and determine which ones are better. The better solutions are then used as the basis for the next generation of solutions, which are generated through a process of mutation and crossover. This process continues until a satisfactory solution is found that meets the desired criteria.

In case the description of existing solutions 214 is missing in the user request 210, the invention algorithm makes use of the database 232, particularly the prior art database to determine existing solutions. Preferably, the database 232 is accessed via or with assistance of the AI function 201, as illustrated by connection 234, so that it is possible to use part, or all the information provided by the user request to phrase a prompt. The prompt for the AI system preferably includes an indication that existing solutions are queried which correspond to the provided information, such as the description of the subject area 212, description of the problems caused by existing solutions 216 and the description of a specific task 218. As described above regarding the subject area, also in this case, it is alternatively possible to select a subset of the information provided in the user query 210 as the basis for the query to the AI function 201 about the subject area and use the other information in a subsequent query to the AI function 201 to refine the result. The other information may alternatively be used to have the AI function 201 check its own answer to see if it matches the additional information provided. If it does not, the algorithm prompts the AI function 201 to revise its previous answer to match the additional information. These additional steps can be used to improve the result provided by the AI function 201. The selection of the subset of information may be done randomly or pseudo randomly or based on a predetermined priority list.

The algorithm according to the invention adjusts the order of processing depending on the availability of the information. For example, if the description of the existing solutions 214 and the description of the problems caused by these existing solutions 216 are missing, the algorithm first performs the actions described above for determining the description of the existing solutions 214 and then performs the actions described above for determining the description of the problems caused by these existing solutions. Although it has been found that the result of the algorithm according to the invention is particularly good when information on all four domains is available for the subsequent steps, the invention algorithm may generate only a subset of the information that is not provided by the user request, e.g., based on a random selection or based on a predetermined priority list.

Activity 235 is an example of the self-leaning aspect of the computing system for making inventions. In activity 235, all or specific parts of the information extracted from the user request 210 and determined in activity 230 are used to generate an abstraction of the user request 210. This is done by creating a prompt based on all or specific parts of the information available from activity 230 and an indication that an abstraction, in the sense of a general idea rather than a specific example, is requested from the AI function 201. After sending the prompt to the AI function 201, an abstraction of the user request is retrieved in the completion returned from the AI function 201. Innovation and technical problem-solving often require a multidisciplinary approach, in a preferred variation the prompt requesting an abstraction to the user request may include an indication to one or more disciplines, so that the user request is not only abstracted but rephrased in the direction of the indicated discipline.

Examples for the disciplines could, e.g., be mathematics, physics, chemistry, biology, psychology, sociology, economics, design. To generate an abstraction, alternatively or additionally, the AI function 201 could be queried to list related areas in technology and science that could be relevant to finding a solution. For example, if the problem is to find a solution for fastening a rain protection for outdoor clothing, related areas in technology and science the AI function 201 returns may include material science, textile engineering, chemistry, fluid mechanics, mechanical engineering, human factors engineering, product design, ergonomics.

Part or all the abstracted information based on the user request 210 is advantageously used to retrieve from the database 232, particularly from the prior art database, related documents. This is advantageously done via or with assistance of the AI function 201, as illustrated by connection 234, so that, e.g., capabilities such as a semantic search may be used for retrieving relevant material.

In a subsequent step, the retrieved material is used to train the AI function 201, as illustrated by the double-lined arrow connecting activity 235 with AI function 201. This can for example be performed by bringing the AI function 201 into a ‘fine tuning’ state, in which the AI uses the provided material for training purpose. By doing so, the computing system for making inventions improves the active knowledge base of its AI function 201 to improve further steps to generate suitable and novel solutions to the given user request 210. Advantageously, measures are taken to keep the generic AI model intact despite the fine-tuning procedure. One approach may be to use transfer learning, where the pre-trained model is used as a starting point, and then only the final layers of the model are trained on the specific task. By freezing the majority of the pre-trained layers, the model can retain its generic features and knowledge while still adapting to the specific task. Another approach is to use a process called distillation, where the fine-tuned model is used to teach the generic model how to perform the specific task. In this case, the fine-tuned model is used as a teacher to generate training examples that are used to train the generic model.

In the provided example regarding a solution for fastening a rain protection for outdoor clothing, the AI function 201, at this point-if all information has been used-has been fine-tuned, or alternatively conditioned, with all retrieved material regarding other disciplines, such as mathematics, physics, chemistry, biology etc. and with the material from the prior art database regarding material science, textile engineering, chemistry, fluid mechanics, mechanical engineering, human factors engineering, product design, ergonomics. The additional training based on the material retrieved due to the abstraction of the user request advantageously allows the AI function 201 to provide suitable and novel solutions that are not only limited to known aspects from the subject area, but advantageously allows for an innovative combination of aspects from different disciplines and or different areas of technology and science.

In activity 240, one or more possible solutions are generated. To do this, the AI function 201 is used to generate this information based on a prompt created by the invention algorithm based on the information provided with the user query 210 and the supplemented information from the activity 230. To make the AI function 201 to generate solutions to the context provided by the description of one or more of the aspects—namely, the description of the subject area 212, the description of existing solutions 214, the description of the problems caused by these existing solutions 216, and the description of a specific task 218—the invention algorithm generates a corresponding prompt that is communicated to the AI function 201. The prompt requests a list of solutions in the described subject area that differ from the existing solutions, avoid the problems caused by the existing solutions, and solve the specified tasks. Since the AI function 201 has been fine-tuned in activity 235 using the material based on the abstracted user request 210, the AI function 201 can draw from the broadened knowledgebase when generating the solutions. However, since the query used in activity 240 is based on the more specific information derived from the user request 210, it is ensured that the suggested solutions are targeted to the sought solution.

Alternatively, it is also possible to select a subset of the information provided with the user request 210 and the supplemented information from the previous activity 230 as the basis for the request to the AI function 201, which requests one or more solutions that match the provided information. The other information is then used in a subsequent request to the AI function 201 to refine the result. For example, in a first iteration, a solution is requested that avoids one of the drawbacks of an existing solution. In a second iteration, the AI function 201 is then requested to provide a refined solution that additionally avoids another drawback.

The other information can alternatively be used to let the AI function 201 check whether the generated solutions meet the requirements imposed by the additional information. If they do not meet these requirements, the algorithm prompts the AI function 201 to revise the previously generated solutions to fit the additional information. These additional steps can be used to improve the result provided by the AI function 201. The selection of the subset of information can be random or pseudo-random or based on a predetermined priority list. The number of iterations can be pre-determined or determined during processing, e.g., based on a comparison of the AI function's result, such that no further iteration is performed when two subsequent outputs of the AI function 201 have a pre-determined degree of similarity. A pre-trained AI function 201 may be used to determine the degree of similarity of the reply used for the decision to stop further iterations. The degree of similarity can, e.g., be determined by using a vector embedding of the results as returned by the AI function 201 in the different iterations and to determine the cosine similarity.

Optionally, a novelty and obviousness check can be performed in activity 250. The solutions generated in the preceding activity 240 are compared individually with the solutions stored in the database 232, preferably in the prior art database. Preferably, the database is accessed via or using the AI function 201, as illustrated by connection 234, so that it is possible to use a subset, or all the information generated in activity 240 to formulate a prompt for the AI system to determine novelty. If the solution is not novel to the prior art and is not the only solution generated in activity 240, it can be deleted from the list and processing can continue with the other solutions. If it is the only solution on the list, the method returns to activity 240 and requests refinement of a solution based on the previous requirements, and with the additional requirement that the solution should also be different from that identified in activity 250, as illustrated with arrow 255. Alternatively, any solutions determined to be non-novel may remain on the list and be passed to activity 240 as previously described. Before looping back to activity 240, the AI function may optionally be fine-tuned with the documents that have been retrieved in the novelty and obviousness search, as illustrated by the double-lined arrow connecting activity 250 with AI function 201. The loop back to activity 240 is terminated for a given solution if the refined solution has a pre-determined degree of similarity to the previously generated or refined solution. A previously trained AI function 201 may be used to determine the degree of similarity of the refined solution compared to the previously generated or refined solution, which is used to decide whether to terminate further loops back to activity 240.

If the AI function 201 did not find and then return a prior art document showing the solution generated in activity 240, the prior art document having the highest similarity to the solution generated in activity 240 is returned. In activity 250 it is then the degree of similarity determined. In case the degree of similarity is over a certain pre-determined threshold, the solution is marked as obvious in view of the prior art document. The threshold my alternatively subject to learning as well.

Alternatively, more than one prior art documents could be retrieved in case a solution is not shown in one single prior art document. The AI function 201 is then used to determine whether the generated solution is a direct combination of two or more of the retrieved prior art documents. Depending on the number of prior art documents necessary to be combined to show the generated solution, the solution is either marked as obvious or as non-obvious. The number of necessary documents may, e.g., be two, however, further aspects may be considered, such as the degree of similarity to each of the returned prior art documents, which could as well be determined by the AI function 201. The degree of similarity can, e.g., be determined by taking generated vector embedding of the solution as disclosed in the different prior art documents and to determine the cosine similarity.

Correspondingly to generated solutions marked as non-novel, generated solutions marked as obvious may be looped back to the generation activity 240 for further refinement, as described above, with the preferred variation that all returned prior art documents are used in the refinement process, and as illustrated with arrow 255.

Following the novelty and obviousness check performed in activity 250 it is checked in activity 260 whether there is at least one generated solution marked as novel. Alternatively, instead of categorical variables novel, non-novel signaled with 1 or 0, probabilities p(novel), p(non-obvious) having values from 0 to 1 are returned and a decision regarding novelty is made based on signaled probabilities.

If none of the solutions is marked as novel, the user is informed about this in activity 265 and the process ends at point 267. It is then up to the user to create a new user request and re-start the process from the beginning at point 202. If there is at least one generated solution that is novel, the one or more solution could be communicated to the user, or processing might be continued as explained with reference to FIG. 1.

For the example in FIG. 2, activity 270 is optionally provided. Activity 270 implements an evaluation step that is used in two different scenarios. The first scenario is when more than one solution has been issued in operation 250. In this case, all solutions are evaluated in terms of the extent to which they match the set requirements, e.g., the extent to which they each perform certain tasks or the extent to which they avoid problems of the existing solutions. A second scenario is when activities 240 and 250 are provided two or more times in parallel (not shown) and in each branch the above-described methods are performed based on a different selection or different order of information when prompting the AI function 201. In such a case it can be expected that the different branches issue different solutions. Also under the second scenario, in activity 270 the different solutions are rated.

In activity 280, an ordered list of the solutions 282 may be output to the user (as depicted here) or forwarded for further processing as described with reference to FIG. 1, as indicated with point 285.

1. A holistic computing system for making and providing new technical and scientific solutions, comprising:
a. a first database containing technical and/or scientific publications;
b. an algorithms database containing and providing an assembly of algorithms to be applied by the system for feature engineering and machine and deep learning purposes to analyze and evaluate the data of said first database;
c. an invention module adapted to manipulate said first database;
d. a system manager adapted to receive a request for the system to provide a solution in response to said request;

2. The holistic computing system according to claim 1, further comprising a result classifier adapted to evaluate and predict the probability of patenting success of the obtained findings.

3. The holistic computing system according to claim 1, further comprising a modular supercomputing infrastructure.

4. The holistic computing system according to claim 1, wherein a result simulator is adapted to run simulation algorithms provided by a deep learning simulation algorithms database.

5. The holistic computing system according to claim 1, further comprising a grant manager which is adapted to receive corresponding legal requirements for patenting the findings from a legal database and matching the findings with the help of grant algorithm in view of the prior art from the first database.

6. The holistic computing system according to claim 5 wherein the grant module further comprises a patent drafting algorithm adapted to draft predefined documents of a patent application.

7. The holistic computing system according to claim 6 wherein the grant module is adapted to file a patent application with a patent office.

8. The holistic computing system according to claim 1 wherein said first database is a self-learning database and contains information from scientific and technical articles, patents, books, existing databases of all kinds of accessible data sources.

9. The holistic computing system according to claim 1 wherein the modular supercomputer infrastructure comprises a plurality of first computing elements configured to perform arithmetic calculations with a first precision, one or more second computing elements configured to perform arithmetic calculations with a second precision.

10. The holistic computing system according to claim 9 wherein said plurality of first computing elements comprise at least one of a group of components, said group comprising: a processing node, a multi-core processor, a general-purpose central processing unit, a scalar processor, a multi-scalar processor, a processor core, a system-on-chip, a computer, a workstation.

11. The holistic computing system according to claim 9 wherein said one or more second computing elements comprise at least one of a group of components, said group comprising: GPU, FPU, FPGA, ASIC, neural processing unit, tensor processing unit, parallel processor.

12. The holistic computing system according to one of the claim 9 wherein the first precision is higher than the second precision.

13. The holistic computing system according to claim 1 wherein the modular supercomputer infrastructure l comprises at least one quantum computing element.

14. The holistic computing system according to claim 1 wherein the system manager is configured to assign a first part of a computational task to one or more of said plurality of first computing elements and a second part of the computational task to one of said one or more second computing elements.

15. The holistic computing system according to claim 14 wherein the computational task is training and inference of a deep learning neural network.

16. A method for making and providing new technical and scientific solutions by a holistic computing system, the holistic computing system comprising a first database containing technical and or scientific publications, an AI function the method comprising the steps:
a. Receiving a user request containing one or more information items of a group of information items, the group of information items comprising: a description of a subject area, a description of existing solutions a description of the problems caused by these existing solutions and a description of a specific task,
b. Analyzing the content of said user request,
c. Abstracting the user request by using said AI function,
d. Retrieving from the first database information related to the abstracted user request,
e. Fine-tuning the AI function using said information related to the abstracted user request retrieved from said first database,
f. Using said fine-tuned AI function to generate a solution based on the information item or items of said user request,
g. Retrieving from said first database information related to said solution generated by using said fine-tuned AI function,
h. Determining the degree of similarity between said solution generated by using said fine-tuned AI function and said information retrieved from said first database related to said solution generated by using said fine-tuned AI function,
i. In case the degree of similarity is over a pre-determined threshold, performing the step of further fine-tuning said fine-tuned AI function using said information related to said solution generated by using said fine-tuned AI function, and repeating the steps f) to h) based on the further fine-tuned AI function,
j. Outputting said generated solution.

17. The method for making and providing new technical and scientific solutions according to claim 16, wherein the step of analyzing the content of said user request, includes the step of generating one or more of information items of said group of information, which were not provided in said user request by using said AI function.
